(19) United States
(12) Patent Application Publication
(10) Pub. No.: US 2022/0093964 A1
(43) Pub. Date: Mar. 24, 2022

(54) ANODE ACTIVE MATERIAL FOR LITHIUM SECONDARY BATTERY, MANUFACTURING METHOD THEREOF, AND LITHIUM SECONDARY BATTERY INCLUDING THE SAME

(71) Applicants: SK INNOVATION CO., LTD., Seoul (KR); UNIST (ULSAN NATIONAL INSTITUTE OF SCIENCE AND TECHNOLOGY), Ulsan (KR)

(72) Inventors: Jee Hee Lee, Daejeon (KR); Sang Jin Kim, Daejeon (KR); Joon Sup Kim, Daejeon (KR); Nam Hyung Kim, Ulsan (KR); Yoon Kwang Lee, Ulsan (KR); Jae Phil Cho, Ulsan (KR)

(21) Appl. No.: 17/540,036

(22) Filed: Dec. 1, 2021

Related U.S. Application Data
(62) Division of application No. 16/042,335, filed on Jul. 23, 2018.

(30) Foreign Application Priority Data
Jul. 21, 2017 (KR) 10-2017-0092785

(51) Int. Cl. H01M 10/0525; H01M 4/133; H01M 10/04; H01M 4/38; H01M 4/587; H01M 4/36; H01M 4/1395; H01M 4/04

(52) U.S. Cl. CPC H01M 10/0525; H01M 4/133; H01M 10/0459; H01M 10/045; H01M 4/0471; H01M 4/587; H01M 4/366; H01M 4/1395; H01M 4/386

(57) ABSTRACT

Provided are an anode active material for a lithium secondary battery, a manufacturing method thereof, and a lithium secondary battery including the same, the anode active material for a lithium secondary battery including: a carbon-based particle; a composite layer positioned on the carbon-based particle and including a silicon particle dispersed in a carbon matrix; and a carbon coating layer positioned on the composite layer.

### CROSS-REFERENCE TO RELATED APPLICATIONS

This application is a division of U.S. patent application Ser. No. 16/042,335 filed on Jul. 23, 2018, which claims priority under 35 U.S.C. § 119 to Korean Patent Application No. 10-2017-0092785, filed on Jul. 21, 2017, in the Korean Intellectual Property Office, the disclosure of which is incorporated herein by reference in its entirety.

### TECHNICAL FIELD

The following disclosure relates to a lithium secondary battery, and more particularly, to an anode active material for a lithium secondary battery, a manufacturing method thereof, and a secondary battery including the same.

### BACKGROUND

Recently, as demand for an electronic device such as a mobile device, and the like, has increased, technology development for the mobile device has expanded. Demand for lithium secondary batteries such as a lithium battery, a lithium ion battery, and a lithium ion polymer battery, and the like, has greatly increased as a driving power source for these electronic devices. In addition, as the automobile fuel economy and exhaust gas-related regulations are being strengthened around the world, and the growth of the electric car market is accelerating. At the same time, demand for mid- to large-sized secondary batteries, such as a secondary battery for electric vehicle (EV) and a secondary battery for energy storage device (ESS), and the like, is expected to surge.

Meanwhile, a carbon-based anode material having an excellent cycle characteristic and a theoretical capacity of 372 mAh/g has been generally used as an anode material of a secondary battery. However, as high capacity of the secondary batteries such as mid- to large-sized secondary battery, and the like, is generally required, an inorganic anode material such as silicon (Si), germanium, tin (Sn), antimony (Sb), or the like, having a capacity of 500 mAh/g or more capable of substituting theoretical capacity of the carbon-based anode material has received attention. Among these inorganic anode materials, a silicon-based anode material shows a very large amount of lithium bonding (theoretical maximum: 3,580 mAh/g, Li₁₅Si₄). However, the silicon-based anode material may cause a large volume change at the time of insertion/desorption of lithium, that is, charging/discharging of the battery to have pulverization. As a result, aggregation of the pulverized particle occurs, and thus an anode active material may be electrically separated from a current collector, which may lead to a loss of a reversible capacity under a long cycle. Therefore, the silicon-based anode material and the secondary battery including the same have drawbacks in that they have a low cycle life characteristic and a capacity retention rate, despite merits of high charge capacity, and thus they have a barrier to practical use.

In order to solve the problems of the silicon-based composite anode material, studies on a silicon-based anode material such as a carbon/silicon composite, or the like, have been actively conducted. However, as an amount of silicon increases, the composite anode material also has a more severe volume expansion when the secondary battery is charged and discharged. Thus, a new surface of the silicon in the composite anode material continues to be exposed to the electrolyte to continuously generate a solid electrolyte interface (SEI) layer, thereby forming a thick side reaction layer, resulting in electrolyte depletion and increased battery resistance. Further, the thick side reaction layer affects not only silicon but also graphite, and there is a problem that performance of the secondary battery such as cycle life characteristics, or the like, is rapidly lowered due to electrical short-circuit phenomenon (peel-off) between anode active material particles or from a current collector.

Therefore, in order to commercialize a high capacity silicon-based composite anode material, it is necessary to develop a technique capable of increasing a content of silicon for high capacity while simultaneously alleviating volume expansion caused by charging and discharging of the secondary battery, thereby preventing deterioration in performance of the secondary battery.

### SUMMARY

An embodiment of the present invention is directed to providing an anode active material for a secondary battery having a high capacity and alleviating volume expansion according to charging and discharging of the secondary battery to have long life characteristics.

Another embodiment of the present invention is directed to providing a manufacturing method capable of economically mass-producing the anode active material having the above-described advantages through a simple process.

Still another embodiment of the present invention is directed to providing a secondary battery including the anode active material having the above-described advantages.

In one general aspect, an anode active material for a lithium secondary battery includes: a carbon-based particle; a composite layer positioned on the carbon-based particle and including a silicon particle dispersed in a carbon matrix; and a carbon coating layer positioned on the composite layer.

The silicon particle in the composite layer may have a form in which an amorphous portion and a crystalline portion are mixed.

A degree of crystallinity of the silicon particle in the composite layer may be 5% or more to 75% or less.

In another general aspect, a manufacturing method of an anode active material for a lithium secondary battery includes: stirring a mixture of a carbon-based particle, a silicon particle, and a first carbon precursor, thereby obtaining a first composite precursor in which the silicon particle dispersed in the first carbon precursor is positioned on the carbon-based particle, stirring a mixture of the first composite precursor and a second carbon precursor, thereby obtaining a second composite precursor in which the second carbon precursor is positioned on the first composite precursor, and firing.

The silicon particle may be an amorphous silicon particle.

The stirring in the obtaining of the first composite precursor and/or the second composite precursor may be performed by spraying a solvent.

A firing temperature in the firing may be 600° C. or more to 700° C. or less.

In still another general aspect, there is provided a lithium secondary battery including an anode that includes the anode active material for a lithium secondary battery as described above.

### BRIEF DESCRIPTION OF THE DRAWINGS

FIGS. 1A and 1B are scanning electron microscope (SEM) images of a silicon carbon composite anode active material manufactured in Example 1.

FIG. 2A is a cross-sectional scanning electron microscope image of the silicon carbon composite anode active material manufactured in Example 1, and FIG. 2B is a cross-sectional scanning electron microscope image showing a more enlarged portion of a coating layer.

FIGS. 3A and 3B are SEM images of a silicon carbon composite anode active material manufactured in Comparative Example 1.

FIGS. 4A and 4B are SEM images of a silicon carbon composite anode active material manufactured in Comparative Example 2.

FIGS. 5A and 5B are Transmission Electron Microscope (TEM) images and Fast Fourier Transform (FFT) patterns of silicon carbon composite anode active materials manufactured in Example 6 and Example 1, respectively.

FIG. 6 shows XRD pattern data of composite layers of the silicon carbon composite anode active materials manufactured in Example 1 and Example 6.

FIG. 7 shows an initial charging/discharging profile of half-cells of Examples 7 to 12.

FIG. 8 shows life characteristics evaluation data for half-cells of Examples 7 to 12, and Comparative Examples 5 and 6.

### DETAILED DESCRIPTION OF MAIN ELEMENTS

1: Carbon coating layer
2: Composite layer
3: Graphite

### DETAILED DESCRIPTION OF EMBODIMENTS

Unless defined otherwise, all terms (including technical and scientific terms) used herein may be used in a sense commonly understood by one of those skilled in the art to which this invention belongs. In addition, a singular form includes a plural form in the present specification unless specifically stated in the context.

It will be understood in the present specification that when an element such as a layer, film, region, or substrate is referred to as being “on” another element, it can be directly on the other element or intervening elements may also be present.

In addition, in the present specification, “˜above” or “˜on” means to be positioned above or below a subject portion and does not necessarily mean that it is positioned on an upper side based on a gravity direction.

In the present specification, “a ratio of B to A” means B/A.

As described above, the demand for mid- to large-sized secondary batteries such as a secondary battery for electric vehicle (EV), a secondary battery for energy storage device (ESS), and the like, is expected to surge. Accordingly, the need for development of a high capacity secondary battery is increasing, and as a part of this, in order to commercialize a silicon-based composite anode material exhibiting a high capacity characteristic, it is necessary to develop a technique capable of increasing a content of silicon for high capacity while simultaneously alleviating volume expansion caused by charging and discharging of the secondary battery, thereby preventing deterioration in performance of the secondary battery.

The present invention relates to an anode active material for a lithium secondary battery capable of increasing a content of silicon as compared to conventionally known anode active material for a secondary battery, thereby implementing high capacity, effectively preventing electrical isolation, peeling phenomenon, and the like, due to volume expansion of silicon caused by charge and discharge of the secondary battery, and preventing a silicon interface from being directly exposed to an electrolyte to suppress generation of side reactions with the electrolyte and depletion of the electrolyte, thereby implementing excellent life characteristics of the secondary battery.

Specifically, an embodiment of the present invention provides an anode active material for a lithium secondary battery including a carbon-based particle; a composite layer positioned on the carbon-based particle and including a silicon particle dispersed in a carbon matrix; and a carbon coating layer positioned on the composite layer.

In the anode active material according to an embodiment of the present invention, the silicon particle may be positioned on the carbon-based particle while being dispersed in the carbon matrix, thereby minimizing direct exposure of the silicon to the electrolyte to reduce the side reaction of the electrolyte, and the volume expansion at the time of charging and discharging the secondary battery may be alleviated, and thus problems such as occurrence of an electrical short-circuit between the silicon particles or from a current collector may be mitigated. Further, the life characteristics of the secondary battery may be improved. In addition, since a large amount of silicon may be contained with respect to a total weight of the anode active material, a high capacity may be implemented. Further, the silicon particle is dispersed in the carbon matrix on the carbon-based particles rather than being attached to a surface of the carbon-based particle, and thus the life characteristics of the secondary battery may be improved.

Further, by further including the carbon coating layer on the composite layer, the silicon particle exposed on the surface of the composite layer may be further covered to further prevent external exposure of the silicon particle, and an effect of suppressing the volume expansion of the silicon may be enhanced.

In the anode active material according to an embodiment of the present invention, on the carbon coating layer on the composite layer, the silicon particle that is inevitably diffused at the time of manufacturing the anode active material to be intermittently positioned in the carbon coating layer may be positioned, and this form is also included in the scope of the present invention. The silicon particle intermittently positioned in the carbon coating layer is distinguished from the silicon particle dispersed in the composite layer. The composite layer and the carbon coating layer having these forms may be confirmed by scanning electron microscope images.

The anode active material having a silicon carbon composite form according to an embodiment of the present invention has a higher capacity and exhibits excellent life characteristics than conventional anode materials.

In the anode active material according to an embodiment of the present invention, the silicon particles in the composite layer may have a form in which an amorphous silicon portion and a crystalline silicon portion are mixed.

In conventionally known silicon carbon composite anode active materials, the silicon mostly has crystallinity. The crystallinity of the silicon induces a selective reaction in a specific crystal plane when the silicon reacts with lithium in a battery to form an alloy. This selective reaction causes an anisotropic expansion of silicon, and the crystalline silicon undergoes a great stress when alloyed with lithium. This leads to deterioration of the anode active material and reduction of battery characteristics.

On the other hand, the amorphous silicon exhibits a non-selective alloying reaction with lithium and isotropic expansion, resulting in less stress when the amorphous silicon is subjected to an alloying reaction with lithium.

Thus, when the silicon particle in the composite layer has a form in which the amorphous portion and the crystalline portion, it is possible to achieve better material characteristics and superior battery characteristics as compared with the crystalline silicon.

Meanwhile, all of the forms as long as it is a form in which the amorphous portion and the crystalline portion of the silicon are mixed, such as not only a form in which each silicon particle in the composite layer has a form in which the amorphous portion and the crystalline portion are mixed, but also a form in which the silicon particle in the composite layer is physically mixed with the crystalline silicon particle and the amorphous silicon particle, and the like, are included in the scope of the present invention.

The description that the amorphous portion and the crystalline portion are mixed in the present invention means that the degree of crystallinity is less than 95% with respect to the entire portion of the silicon particles in the composite layer. More specifically, it may mean that the degree of crystallinity is more than 0% but less than 95%. The degree of crystallinity may be calculated from the Raman spectrum of the composite layer silicon, and specifically, may be calculated by dividing an area of the Raman peak representing the crystalline silicon in the composite layer by an area of the Raman peak representing the entire silicon including the crystalline and amorphous phases in the composite layer.

Since the degree of crystallinity of the silicon particle in the composite layer is less than 95%, the composite layer undergoes less stress during an alloying reaction with lithium (i.e., charging/discharging of the secondary battery), and thus volume expansion may be mitigated. As a result, it is possible to prevent deterioration of the anode and prevent deterioration of battery characteristics such as life characteristics, and the like.

In the anode active material of an embodiment of the present invention, as an example to be described below, the composite layer on the carbon-based material may be formed by mechanically mixing a carbon precursor such as carbon-based particle, amorphous silicon particle, pitch, or the like, followed by firing. Here, partial crystallization is generated in the amorphous silicon in the firing process, which may vary depending on a firing temperature, and there is a tendency that as the firing temperature increases, the degree of crystallization becomes high.

As the degree of crystallinity of the composite layer is lower, it is preferable in view of volume expansion. However, in consideration of proper carbonization temperature of the carbon precursor, such as pitch, or the like, the upper limit of the degree of crystallinity of the composite layer may be 90% or less, 80% or less, 75% or less, 74.9% or less, 70% or less, 60% or less, 50% or less, 40% or less, 30% or less, or 15% or less, and more specifically, 75% or less. The lower limit of the degree of crystallinity of the composite layer may be, for example, 0% or more (when 0%, it means amorphous), 5% or more, 10% or more, 20% or more, or 30% or more. More specifically, as supported by Examples to be described below, in consideration that when a carbonization temperature of the carbon precursor such as the pitch, or the like, is excessively low, the degree of crystallization of the composite layer may be lowered, but the carbon precursor may not be sufficiently carbonized, and thus initial efficiency and life characteristics of the secondary battery may be relatively low, the lower limit thereof is preferably 5% or more.

The anode active material of an embodiment of the present invention is not particularly limited, but may include 10 wt % or more to 90 wt % or less of the carbon-based particle, 5 wt % or more to 50 wt % or less of the composite layer, and 5 wt % or more to 40 wt % or less of the carbon coating layer, with respect to a total weight of the anode active material. More specifically, the anode active material may include 30 wt % or more to 90 wt % or less of the carbon-based particle, 5 wt % or more to 40 wt % or less of the composite layer, and 5 wt % or more to 30 wt % or less of the carbon coating layer.

In addition, the silicon particle may be included in an amount of 0.5 wt % or more to 30 wt % or less, preferably 5 wt % or more to 20 wt % or less, more preferably 8 wt % or more to 20 wt % or less, 10 wt % or more to 20 wt % or less, 11 wt % or more to 20 wt % or less, or 11 wt % or more to 15 wt % or less, with respect to the total weight of the anode active material, but the present invention is not specifically limited thereto. When silicon is included in this range, a high capacity characteristic may be implemented as compared with known silicon carbon composite anode active materials.

A thickness of the composite layer of the anode active material of an embodiment of the present invention is not particularly limited, but may be 0.01 μm or more to 10 μm or less. Meanwhile, when the thickness of the composite layer is excessively thick, since the composite layer is thickened, magnitude of stress applied to the composite layer increases according to the volume expansion of the silicon during charging and discharging of the secondary battery, and thus the anode may be deteriorated and the life characteristics of the secondary battery may be poor. Thus, the thickness of the composite layer is preferably 0.1 μm or more to 4 μm or less.

Meanwhile, boundaries among the carbon-based particle, the composite layer, and the carbon coating layer may be confirmed by a cross-sectional scanning electron microscope image, and a thickness of each layer may be measured therefrom.

The thickness of the carbon coating layer positioned on the composite layer of the anode active material of an embodiment of the present invention is not particularly limited but is preferably 0.01 μm or more to 10 μm or less, preferably 0.1 μm or more to 5 μm or less, and more preferably 0.2 μm or more to 1 μm or less. By positioning the carbon coating layer within a thickness range, it is possible to prevent the surface of the silicon particle from being exposed by covering the silicon particle exposed on the surface of the composite layer. Thus, the problem caused by the volume expansion of the silicon particle may be mitigated.

The carbon-based particle of the anode active material of an embodiment of the present invention is not limited thereto, but may be, for example, a crystalline carbon-based particle, and more specifically, may be a graphite particle.

An average particle diameter of the carbon-based particle of the anode active material of an embodiment of the present invention is not particularly limited, but may be 1 μm or more to 100 μm or less, preferably 3 μm or more to 40 μm or less, and more preferably 5 μm or more to 20 μm or less.

The average particle diameter of the silicon particle of an embodiment of the present invention is not particularly limited, but may be 1 nm or more to 500 nm or less, preferably 5 nm or more to 200 nm or less, and more preferably 10 nm or more to 100 nm or less.

Excellent capacity characteristics and life characteristics may be implemented in the average particle diameter ranges of the carbon-based particle and the silicon particle.

Meanwhile, in the present specification, the average particle diameter means a value measured as a volume average value D50 (that is, a particle diameter when the cumulative volume becomes 50%) in measurement of particle size distribution by laser light diffraction.

Another embodiment of the present invention provides a manufacturing method of an anode active material for a lithium secondary battery including: stirring a mixture of a carbon-based particle, a silicon particle, and a first carbon precursor, thereby obtaining a first composite precursor in which the silicon particle dispersed in the first carbon precursor is positioned on the carbon-based particle, stirring a mixture of the first composite precursor and a second carbon precursor, thereby obtaining a second composite precursor in which the second carbon precursor is positioned on the first composite precursor, and firing.

This is a method capable of manufacturing the anode active material according to an embodiment of the present invention described above. In addition, this method has an advantage in that the anode active material of the present invention is capable of being mass-produced through a very simple process by mixing and stirring the carbon-based particle, the silicon particle, and the carbon precursor.

Hereinafter, the manufacturing method will be described in more detail. The above-described portions regarding materials such as the kind and the average particle diameter of the carbon-based particle, the average particle diameter of the silicon particle, and the like, are omitted.

First, a mixture of the carbon-based particle, the silicon particle, and the first carbon precursor is stirred to obtain a first composite precursor in which the silicon particle dispersed in the first carbon precursor is positioned on the carbon-based particle.

Here, the silicon particle may be an amorphous silicon particle. By using the amorphous silicon particle, silicon in the composite layer of the finally manufactured anode active material may have a form in which the amorphous portion and the crystalline portion are mixed. Thus, as described above, as the amorphous silicon is included in the composite layer, the volume expansion according to charge and discharge may be alleviated to improve battery characteristics such as life characteristics, and the like. Meanwhile, it is possible to form the composite layer in various forms in which the amorphous portion and the crystalline portion of the silicon are mixed including not only a form in which each silicon particle in the composite layer has a form in which the amorphous portion and the crystalline portion are mixed, but also a form in which the silicon particle in the composite layer is physically mixed with the crystalline silicon particle and the amorphous silicon particle, and the like.

Further, by positioning the silicon particle and the first carbon precursor on the carbon-based particle through stirring, the silicon particle may be dispersed and positioned in the first carbon precursor, and a large amount of silicon may be positioned on the carbon-based particle. Thus, a high capacity silicon carbon composite anode active material may be manufactured.

Meanwhile, an organic solvent may be sprayed for more smooth dispersion of the carbon-based particle, the silicon particle, and the first carbon precursor at the time of stirring. By spraying a small amount of the organic solvent, stirring may be performed in a high viscosity solution state to obtain the first composite precursor. In this case, as the dispersibility is improved, the silicon particles may be further dispersed and positioned in the first carbon precursor, and thus it may be expected to increase the silicon content in the anode active material and improve the battery characteristics. The organic solvent may be, for example, tetrahydrofuran (THF), but is not limited thereto.

The stirring manner may be mechanical stirring and may be performed by a particle mixer. The particle mixer is not particularly limited, but the stirring may be performed by a rotating stirrer, a revolving stirrer, a blade mixer, or a particle fusion machine.

The first carbon precursor may be, but is not limited to, a carbon precursor selected from the group including pitch-based, PAN-based, rayon-based, and a combination thereof.

Then, a mixture of the obtained first composite precursor and a second carbon precursor may be stirred and the second carbon precursor may be positioned on the first composite precursor. Through this step, the silicon particle exposed on the surface of the first composite precursor may be covered with the second carbon precursor, thereby reducing the exposure of the surface. Accordingly, the silicon particle exposed on the surface of the finally manufactured anode active material may be minimized to prevent the silicon from being directly exposed to the electrolyte, thereby improving the life characteristics.

The stirring manner in this step may be mechanical stirring and may be performed by a particle mixer. The particle mixer is not particularly limited, but the stirring may be performed by a rotating stirrer, a revolving stirrer, a blade mixer, or a particle fusion machine.

The second carbon precursor may be, but is not limited to, a carbon precursor selected from the group including pitch-based, PAN-based, rayon-based, or a combination thereof.

In addition, the first carbon precursor and the second carbon precursor may be the same as each other or may be different.

During the stirring in this step, an organic solvent may be sprayed for better dispersion of the first composite precursor and the second carbon precursor. In this case, through more smooth dispersion, compactness of the carbon coating layer formed from the second carbon precursor may be improved and improvement of the battery characteristics may be expected.

Meanwhile, in the manufacturing method of the anode active material according to an embodiment of the present invention, 10 wt % or more to 90 wt % or less of the carbon-based particle, 5 wt % or more to 50 wt % or less of the sum of the silicon particle and the first carbon precursor, and 5 wt % or more to 40 wt % or less of the second carbon precursor may be mixed with respect to a total mixed amount of the carbon-based particle, the silicon particle, the first carbon precursor, and the second carbon precursor, but the present invention is not particularly limited thereto. More specifically, 30 wt % or more to 90 wt % or less of the carbon-based particle, 5 wt % or more to 40 wt % or less of the sum of the silicon particle and the first carbon precursor, and 5 wt % or more to 30 wt % or less of the second carbon precursor may be mixed.

In addition, 0.5 wt % or more to 30 wt % or less, preferably 5 wt % or more to 20 wt % or less of the silicon particle, more preferably 8 wt % or more to 15 wt % or less, 10 wt % or more to 20 wt % or less, 11 wt % or more to 20 wt % or less, or 11 wt % or more to 15 wt % or less may be mixed with respect to a total mixed amount of the carbon-based particle, the silicon particle, the first carbon precursor, and the second carbon precursor, but the present invention is not particularly limited thereto. When silicon is included in this range, a high capacity characteristic may be implemented as compared with conventionally known silicon carbon composite anode active materials.

Meanwhile, an exemplary mixing ratio of the first carbon precursor and the second carbon precursor with respect to a mixed amount of the silicon particle may be 0.6/1 or more on a weight basis.

Further, when a mixing ratio of the first carbon precursor and the second carbon precursor with respect to the mixed amount of the silicon particle is excessively small, the composite layer and the carbon coating layer on the composite layer may not be sufficiently formed, and thus the graphite surface may be exposed to the outside, or the silicon particle may be exposed to the surface in a large amount, which may cause a problem that a structure of the anode active material according to an embodiment of the present invention is not able to be formed. The upper limit of the mixing ratio of the first carbon precursor and the second carbon precursor with respect to the mixed amount of the silicon particle is not particularly limited, but may be less than 2/1, more preferably 1.5/1 or less.

Hereinafter, the firing will be described.

In this step, a material in which the second carbon precursor is positioned on the first composite precursor obtained through the above-described manufacturing steps is heat-treated to carbonize the first and second carbon precursors, thereby finally manufacturing the anode active material including: a carbon-based particle; a composite layer positioned on the carbon-based particle and including a silicon particle dispersed in a carbon matrix; and a carbon coating layer positioned on the composite layer.

The firing in this step may be performed in an inert atmosphere, for example, in an atmosphere of argon (Ar), helium (He), or nitrogen (N₂). However, the present invention is not limited thereto.

A firing temperature in this step is not particularly limited, but may be 300° C. or more to 1200° C. or less. More specifically, the firing temperature may be 600° C. or more to 700° C. or less. When the firing temperature is excessively low, carbonization of the carbon precursor does not proceed sufficiently, and thus initial efficiency or life characteristics of the secondary battery in which the manufactured anode active material is employed may be relatively deteriorated as compared with a case where the firing temperature is within the above-described range. When the firing temperature is excessively high, crystallization of the amorphous silicon excessively occurs, and thus the life characteristics of the secondary battery in which the manufactured anode active material is employed may be relatively deteriorated as compared with a case where the firing temperature is within the above-described range.

The pressure and the firing time of the firing step are not limited to specific ranges.

In still another general aspect, there is provided a lithium secondary battery including an anode that includes the anode active material for a lithium secondary battery as described above.

This is a lithium secondary battery including the anode active material having the above-described characteristics to be capable of securing stability even when repeatedly charged and discharged, alleviating volume expansion, and improving battery characteristics such as high capacity and life characteristics, and the like, of the lithium secondary battery.

Here, the lithium secondary battery may further include a cathode and an electrolyte, and may further include a separator interposed between the cathode and the anode.

The lithium secondary battery may be classified into a lithium ion battery, a lithium ion polymer battery, and a lithium polymer battery according to kinds of the separator and the electrolyte to be used, or may be classified into a cylindrical shape, a prismatic shape, a coin shape, a pouch shape, and the like, according to shape, or may be classified into a bulk type and a thin film type according to size. Since structures and manufacturing methods of these batteries are widely known in the art, minimum description thereof is added.

First, the anode includes a current collector and an anode active material layer formed on the current collector, and the anode active material layer may include an anode active material according to an embodiment of the present invention described above. The description of the anode active material is omitted since it is the same as described above.

The anode active material layer further includes an anode binder, and optionally, may further include a conductive material.

The anode binder functions to adhere anode active material particles well to each other and further to adhere the anode active material to the current collector. As the binder, a water-insoluble binder, a water-soluble binder, or a combination thereof may be used.

Examples of the water-insoluble binder may include polyvinyl chloride, carboxylated polyvinyl chloride, polyvinyl fluoride, a polymer including ethylene oxide, polyvinyl pyrrolidone, polyurethane, polytetrafluoroethylene, polyvinylidene fluoride, polyethylene, polypropylene, polyamideimide, polyimide, or a combination thereof.

Examples of the water-soluble binder may include styrene-butadiene rubber, acrylated styrene-butadiene rubber, polyvinyl alcohol, sodium polyacrylate, copolymer of propylene and C2-C8 olefin, copolymer of (meth)acrylic acid and (meth)acrylic acid alkyl ester or a combination thereof.

When the water-soluble binder is used as the anode binder, a cellulose-based compound capable of imparting viscosity may be further included. As the cellulose-based compound, at least one of carboxymethyl cellulose, hydroxypropylmethyl cellulose, methyl cellulose, alkali metal salts thereof, and the like, may be mixed to be used. As the alkali metal, Na, K or Li may be used. A used content of the thickener may be 0.1 to 3 parts by weight with respect to 100 parts by weight of the binder.

In addition, the conductive material is used to provide conductivity to the electrode. As the conductive material, any electro-conductive material may be used as long as chemical changes do not occur in a battery to be constituted. Examples of the conductive material may include a carbon-based material such as natural graphite, artificial graphite, carbon black, acetylene black, Ketjen black, carbon fiber, or the like; a metal-based material such as metal powder, metal fiber, or the like, including copper, nickel, aluminum, silver, or the like; a conductive polymer such as polyphenylene derivative, or the like; or a conductive material including a mixture thereof.

In addition thereto, the current collector may be selected from the group consisting of a copper foil, a nickel foil, a stainless steel foil, a titanium foil, a nickel foam, a copper foam, a polymer substrate coated with conductive metal, and a combinations thereof.

Meanwhile, the cathode includes a current collector and a cathode active material layer formed on the current collector. As the cathode active material, a compound capable of reversibly intercalating and deintercalating lithium (a lithiated intercalation compound) may be used. Specifically, at least one of composite oxides of lithium and metal selected from cobalt, manganese, nickel, and a combination thereof may be used. As a more specific example, a compound represented by any one of the following Chemical Formulas may be used:

LiₐA_{1-b}X_{b}D₂ (0.90≤a≤1.8, 0≤b≤0.5); LiₐA_{1-b}X_{b}O_{2-c}D_{c} (0.90≤a≤1. 8, 0≤b≤0.5, 0≤c≤0.05); LiE_{1-b}X_{b}O_{2-c}D_{c} (0≤b≤0.5, 0≤c≤0.05); LiE_{2-b}X_{b}O_{4-c}D_{c} (0≤b≤0.5, 0≤c≤0.05); LiₐNi_{1-b-c}Co_{b}X_{c}D_{α} (0.90≤a≤1.8, 0≤b≤0.5, 0≤c≤0.05, 0<α≤2); LiₐNi_{1-b-c}Co_{b}X_{c}O_{2-α}T_{α} (0.90≤a≤1.8, 0≤b≤0.5, 0≤c≤0.05, 0<α<2); LiₐNi_{1-b-c}Co_{b}X_{c}O_{2-α}T₂ (0.90≤a≤1.8, 0≤b≤0.5, 0≤c≤0.05, 0<α<2); LiₐNi_{1-b-c}Mn_{b}X_{c}D_{α} (0.90≤a≤1.8, 0≤b≤0.5, 0≤c≤0.05, 0<α≤2); LiₐNi_{1-b-c}Mn_{b}X_{c}O_{2-α}T_{α} (0.90≤a≤1.8, 0≤b≤0.5, 0≤c≤0.05, 0<α<2); LiₐNi_{1-b-c}Mn_{b}X_{c}O_{2-α}T₂ (0.90≤a≤1.8, 0≤b≤0.5, 0≤c≤0.05, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMnG_{b}O₂ (0.90≤a≤1.8, 0.001≤b≤0.1); LiₐMn₂G_{b}O₄ (0.90≤a≤1.8, 0.001≤b≤0.1); LiₐMnG_{b}PO₄ (0.90≤a≤1.8, 0.001≤b≤0.1); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃ (0≤f≤2); LiFePO₄.

In the above Chemical Formula, A is selected from the group consisting of Ni, Co, Mn, and a combination thereof; X is selected from the group consisting of Al, Ni, Co, Mn, Cr, Fe, Mg, Sr, V, rare earth element and a combination thereof; D is selected from the group consisting of O, F, S, P, and a combination thereof; E is selected from the group consisting of Co, Mn, and a combination thereof; T is selected from the group consisting of F, S, P, and a combination thereof; G is selected from the group consisting of Al, Cr, Mn, Fe, Mg, La, Ce, Sr, V, and a combination thereof; Q is selected from the group consisting of Ti, Mo, Mn, and a combination thereof; Z is selected from the group consisting of Cr, V, Fe, Sc, Y, and a combination thereof; and J is selected from the group consisting of V, Cr, Mn, Co, Ni, Cu, and a combination thereof.

The compound may have a coating layer on a surface thereof, or the compound may be mixed with a compound having a coating layer. The coating layer may include at least one coating element compound selected from the group consisting of oxide of coating elements, hydroxide of coating elements, oxyhydroxide of coating elements, oxycarbonate of coating elements, and hydroxycarbonate of coating elements. The compound constituting these coating layers may be amorphous or crystalline. As the coating element included in the coating layer, Mg, Al, Co, K, Na, Ca, Si, Ti, V, Sn, Ge, Ga, B, As, Zr or a mixture thereof may be used. A process of forming the coating layer may be any coating method as long as it does not adversely affect physical properties of the cathode active material by using these elements in the compound (e.g., spray coating, dipping, etc.), and it will be understood by those skilled in the art, and thus a detailed description thereof will be omitted.

The cathode active material layer also includes a cathode binder and a conductive material.

The binder serves to excellently adhere anode active material particles to each other, and excellently adhere the anode active material to a current collector. Representative examples of the binder may include polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like. However, the present invention is not limited to these exemplified binders.

The conductive material is used to provide conductivity to the electrode. As the conductive material, any electro-conductive material may be used as long as chemical changes do not occur in a battery to be configured. As an example, metal powder or metal fiber such as natural graphite, artificial graphite, carbon black, acetylene black, Ketjen black, carbon fiber, copper, nickel, aluminum, and silver, or the like, may be used, and further, at least one conductive material such as polyphenylene derivative, or the like, may be mixed to be used.

Further, the current collector may be aluminum (Al), but the present invention is not limited thereto.

The anode and the cathode may be manufactured, respectively, by mixing each active material, conductive material, and a binder in a solvent to manufacture each active material composition, and applying the composition on a current collector. Since methods of manufacturing electrodes as described above are widely known in the art, detailed description thereof will be omitted in the present specification. The solvent may be N-methylpyrrolidone, or the like, but the present invention is not limited thereto.

Meanwhile, the lithium secondary battery may be a non-aqueous electrolyte secondary battery, and the non-aqueous electrolyte may include a non-aqueous organic solvent and a lithium salt.

The non-aqueous organic solvent serves as a medium through which ions involved in an electrochemical reaction of the battery are movable.

Further, as described above, a separator may be present between the cathode and the anode. As the separator, polyethylene, polypropylene, polyvinylidene fluoride or a multilayer film including two or more layers thereof may be used, and a mixed multilayer film such as a polyethylene/polypropylene two-layer separator, a polyethylene/polypropylene/polyethylene three-layer separator, and a polypropylene/polyethylene/polypropylene three-layer separator, or the like, may be used.

Hereinafter, preferred Examples and Comparative Examples of the present invention will be described. However, the following Examples are merely provided as a preferable exemplary embodiment of the present invention. Therefore, it is to be noted that the present invention is not limited to the following Examples.

Evaluation Method

(1) Measurement of Initial Discharge Capacity

The battery was charged by applying a constant current at a current of 0.1 C rate at 25° C. until the battery voltage reached 0.01 V (vs. Li), and when the battery voltage reached 0.01 V (vs. Li), the battery was charged by applying a constant voltage until the current reached 0.01 C rate.

At the time of discharging, the battery was discharged at a constant current of 0.1 C rate until the voltage reached 1.5 V (vs. Li).

(2) Evaluation of Life Characteristics

The battery was charged by applying a constant current at a current of 0.5 C rate at 25° C. until the battery voltage reached 0.01 V (vs. Li), and when the battery voltage reached 0.01 V (vs. Li), the battery was charged by applying a constant voltage until the current reached 0.01 C rate. At the time of discharging, a cycle of discharging the battery at a constant current of 0.5 C rate until the voltage reached 1.5 V, was repeated 50 times.

### EXAMPLE 1

11 wt % of amorphous silicon (Si) particle having an average particle diameter of 200 nm, 76 wt % of graphite particle having an average particle diameter of 20 μm and 6.5 wt % of a pitch (25° C. viscosity≥10⁵ cP) were dispersed without a solvent, followed by mechanical stirring, thereby obtaining a first composite precursor in which the silicon particle was dispersed in the pitch on the graphite particle.

A second composite precursor was obtained by adding 6.5 wt % of pitch to the first composite precursor and then positioning the pitch on the first composite precursor through mechanical stirring.

Thereafter, firing was performed in a nitrogen (N₂) atmosphere at 700° C. for 1 hour to manufacture a silicon carbon composite anode active material. The anode active material had a structure in which the composite layer including the silicon particle dispersed in the carbon matrix was positioned on the graphite particle, and the composite layer was surrounded by the carbon coating layer.

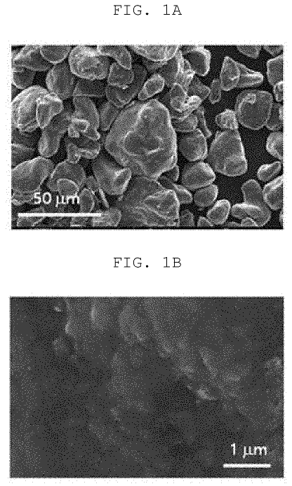

FIGS. 1A and 1B are SEM images (Verios 460 manufactured by FEI) of the manufactured silicon carbon composite anode active materials. The composite layer was coated by the outermost carbon coating layer, and thus it could be confirmed that no silicon particle was exposed on the surface of the anode active material.

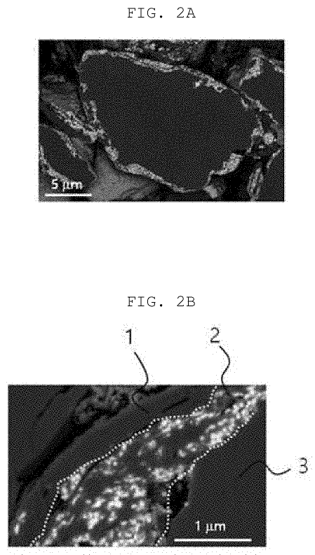

FIG. 2A is a cross-sectional scanning electron microscope image of the manufactured silicon carbon composite anode active material, and FIG. 2B is a cross-sectional scanning electron microscope image showing a more enlarged portion of the coating layer. It could be confirmed that the composite layer in which silicon particle was uniformly dispersed in the carbon matrix was formed on the graphite particle and the carbon coating layer was formed on the composite layer. It was confirmed that the composite layer had a thickness of about 0.2 μm or more to 3 μm or less, and the outermost carbon coating layer had a thickness of about 200 nm or more to about 1 μm or less.

### EXAMPLE 2

A silicon carbon composite anode active material was manufactured in the same manner as in Example 1 except that the firing temperature with respect to the second composite precursor was set to 600° C.

### EXAMPLE 3

A silicon carbon composite anode active material was manufactured in the same manner as in Example 1 except that the firing temperature with respect to the second composite precursor was set to 500° C.

### EXAMPLE 4

A silicon carbon composite anode active material was manufactured in the same manner as in Example 1 except that the firing temperature with respect to the second composite precursor was set to 850° C.

### EXAMPLE 5

A silicon carbon composite anode active material was manufactured in the same manner as in Example 1 except that the firing temperature with respect to the second composite precursor was set to 300° C.

### EXAMPLE 6

A silicon carbon composite anode active material was manufactured in the same manner as in Example 1 except that crystalline silicon particle was used as the silicon particle.

### COMPARATIVE EXAMPLE 1

A silicon carbon composite anode active material was manufactured in the same manner as in Example 1 except that 11 wt % of amorphous silicon particle, 83 wt % of graphite particle and 3 wt % of pitch were used in the obtaining of the first composite precursor, and 3 wt % of pitch was used in the synthesizing of the second composite precursor.

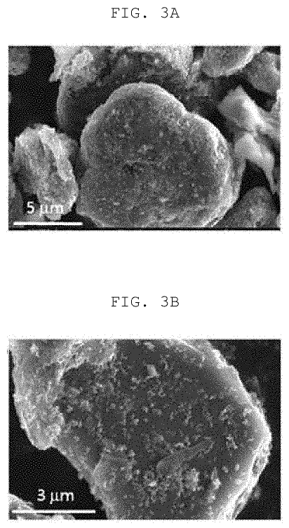

FIGS. 3A and 3B are SEM images of the manufactured silicon carbon composite anode active material. Since the content of the total pitch relative to the content of the silicon particle was small, it could be confirmed that the composite layer and the carbon coating layer on the composite layer were not formed on the surface of the graphite particle, and the graphite particle was exposed to the surface, or the silicon particle was exposed to the surface.

### COMPARATIVE EXAMPLE 2

A silicon carbon composite anode active material in which no carbon coating layer was formed on the composite layer was manufactured. That is, the first composite precursor was obtained in Example 1, and the first composite precursor was immediately fired in the same manner as in Example 1 without positioning the second carbon precursor on the first composite precursor, thereby manufacturing an anode active material in which only a composite layer in which silicon particle was uniformly dispersed in a carbon matrix was positioned on the graphite particle.

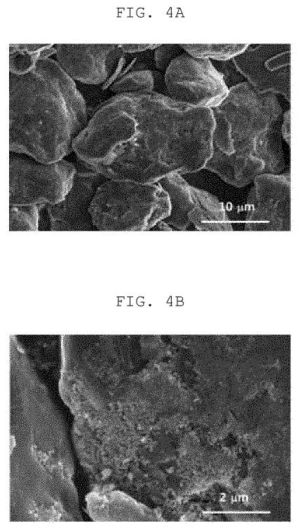

FIGS. 4A and 4B are SEM images of the manufactured silicon carbon composite anode active material. It could be confirmed that the silicon particles were exposed on the surface of the anode active material since no carbon coating layer was formed on the first composite layer.

### COMPARATIVE EXAMPLE 3

Carbon coating was performed by chemical vapor deposition on the graphite particle having an average particle diameter of 20 μm. Specifically, 50 g of the graphite particle was heated up from room temperature to 900° C. in an inert atmosphere (N₂) at a rate of 5° C. per minute, and 1.5 L/min of ethylene (C₂H₂) gas was flowed for 30 minutes when the temperature reached 900° C.

Then, SiH₄ (g) was chemically deposited at a rate of 50 sccm/60 min to form a silicon coating layer on the carbon layer coated by chemical vapor deposition.

Then, C₂H₂ (g) was pyrolyzed at a rate of 1.5 L/min under a temperature condition of 900° C. to manufacture an anode active material in which the carbon layer is coated on the silicon coating layer.

The components were confirmed to be 86.5 wt % of graphite, 3.0 wt % of carbon coating layer on graphite, 8.5 wt % of silicon, and 2.0 wt % of outermost carbon coating layer, with respect to the total weight of the manufactured anode active material.

### COMPARATIVE EXAMPLE 4

Carbon coating was performed on the graphite particle having an average particle diameter of 20 μm through a sol-gel method. Specifically, sucrose was used as a carbon precursor, and first, 5 g of sucrose was dissolved by mixing water and ethanol at 9:1.

When sucrose is carbonized in a high temperature inert atmosphere, only carbon remains at about 30% of the total added amount. Thus 5 g of sucrose was added to 50 g of graphite so that about 3.0 wt % of carbon remained with respect to the total weight of 50 g of graphite+carbon.

Then, 50 g of the graphite particle was added to the solution in which the sucrose was dissolved, and the solvent was evaporated at 100° C. while stirring continuously. The solid thus obtained was charged into an inert atmosphere (N₂) furnace and carbonized at 900° C. for 10 minutes, and the obtained powder was filtered through a micro sieve.

Then, SiH₄ (g) was chemically deposited at a rate of 50 sccm/60 min to form a silicon coating layer on the carbon layer coated by the sol-gel method.

Next, C₂H₂ (g) was pyrolyzed at a rate of 1.5 L/min under a temperature condition of 900° C. to manufacture an anode active material in which the carbon layer is coated on the silicon coating layer.

The components were confirmed to be 86.5 wt % of graphite, 1.5 wt % of carbon coating layer on graphite, 8.5 wt % of silicon, and 3.5 wt % of outermost carbon coating layer, with respect to the total weight of the manufactured anode active material.

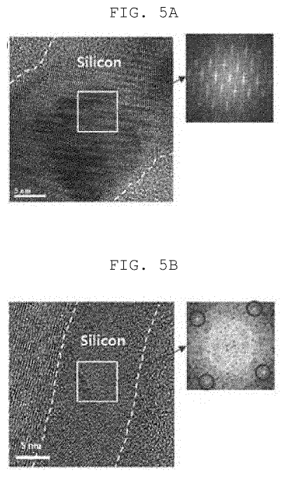

FIGS. 5A and 5B are Transmission Electron Microscope (TEM, JEM-2100F manufactured by FEI) images and Fast Fourier Transform (FFT, Aztec manufactured by Oxford) patterns of the silicon carbon composite anode active materials manufactured in Example 6 and Example 1, respectively.

It could be confirmed that the silicon in the composite layer of Example 6 formed from the crystalline silicon of FIG. 5A was crystalline silicon, and it could be appreciated that the silicon in the composite layer of Example 1 formed from the amorphous silicon of FIG. 5B had a form in which a crystalline portion and an amorphous portion were mixed.

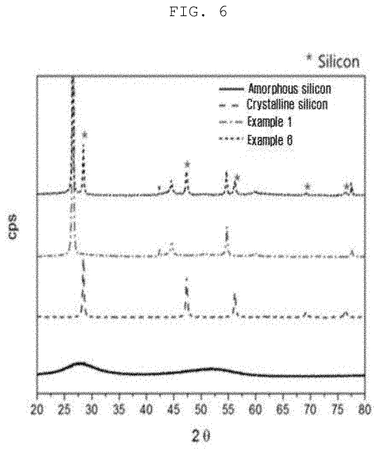

FIG. 6 shows XRD pattern data (D/Max2000 manufactured by Rigaku) of the composite layers of the silicon carbon composite anode active materials manufactured in Example 1 and Example 6. It could be appreciated that in Example 6, all peaks appearing in the crystalline silicon were maintained, but in Example 1, the peaks appearing in the crystalline silicon were weakened or disappeared. This means that the silicon in the composite layer of Example 1 had a form in which the crystalline portion and the amorphous portion were mixed.

Table 1 shows the degree of crystallinity of the composite layer calculated from Raman spectrum (NRS-5100 manufactured by JASCO) with respect to the composite layers of the silicon carbon composite anode active materials manufactured in Examples 1 to 6.

The degree of crystallinity was calculated by dividing the peak area of the crystalline silicon in the complex layer by the peak area of the entire silicon in the crystalline and amorphous phases in the composite layer in the Raman spectrum of each Example.

TABLE 1

| Classification | Degree of crystallinity (%) |
|---|---|
| Example 1 | 74.9 |
| Example 2 | 5.0 |
| Example 3 | 0.0 |
| Example 4 | 91.0 |
| Example 5 | 0.0 |
| Example 6 | 95.0 |

### EXAMPLE 7

The silicon carbon composite anode active material manufactured in Example 1, a conductive material and a binder were mixed in distilled water at a ratio of 95:1:4, thereby preparing a slurry. Here, as the conductive material, carbon black (super-P) was used, and as the binder, sodium carboxymethyl cellulose and styrene butadiene rubber were used at a ratio of 1:1.

The slurry was uniformly coated on a copper foil, dried in an oven at 80° C. for about 2 hours, roll-pressed with 50 μm, and further dried in a vacuum oven at 110° C. for about 12 hours to manufacture an anode plate.

The above-manufactured anode plate, a lithium foil as a counter electrode, a porous polyethylene film as a separator, and a liquid electrolyte in which LiPF₆ was dissolved at a concentration of 1.3 M in a solvent in which ethylene carbonate and diethyl carbonate (DEC) were mixed in a volume ratio of 3:7, and 10 wt % of fluoro-ethylene carbonate (FEC) was contained, were used to manufacture a CR2016 coin type half-cell according to a conventionally known manufacturing process.

### EXAMPLES 8 TO 12

A half-cell was manufactured in the same manner as in Example 7, except that the anode active material manufactured in Examples 2 to 6 was used.

### COMPARATIVE EXAMPLE 5

A half-cell was manufactured in the same manner as in Example 7, except that the anode active material manufactured in Comparative Example 1 was used.

### COMPARATIVE EXAMPLE 6

A half-cell was manufactured in the same manner as in Example 7, except that the anode active material manufactured in Comparative Example 2 was used.

### COMPARATIVE EXAMPLE 7

A half-cell was manufactured in the same manner as in Example 7, except that the anode active material manufactured in Comparative Example 3 was used.

### COMPARATIVE EXAMPLE 8

A half-cell was manufactured in the same manner as in Example 7, except that the anode active material manufactured in Comparative Example 4 was used.

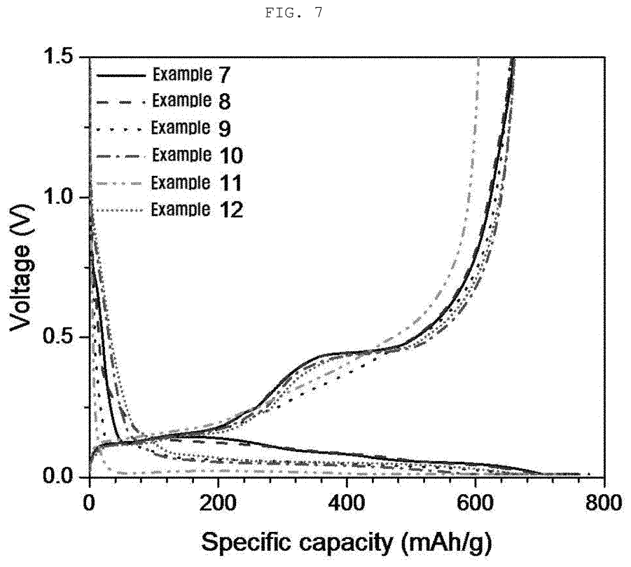

FIG. 7 shows the initial charging/discharging profile and measurement results of the half-cells of Examples 7 to 12, and Table 2 shows initial charging/discharging capacity measurement results of the half-cells of Examples 7 to 12, Comparative Example 7, and Comparative Example 8. As appreciated from FIG. 7 and Table 2, it could be appreciated that the silicon carbon anode active material of the present invention exhibited a discharge capacity of 600 mAh/g or more and an initial efficiency of 83% or more, and had excellent initial discharge capacity and the initial efficiency than those of Comparative Examples 7 and 8.

TABLE 2

| | Initial discharge | Initial |
|---|---|---|
| Classification | capacity (mAh/g) | efficiency (%) |
| Example 7 | 655 | 87.6 |
| Example 8 | 658 | 86.2 |
| Example 9 | 651 | 84.2 |
| Example 10 | 660 | 88.4 |
| Example 11 | 605 | 83.0 |
| Example 12 | 660 | 88.2 |
| Comparative | 575 | 81.7 |
| Example 7 | | |
| Comparative | 553 | 82.2 |
| Example 8 | | |

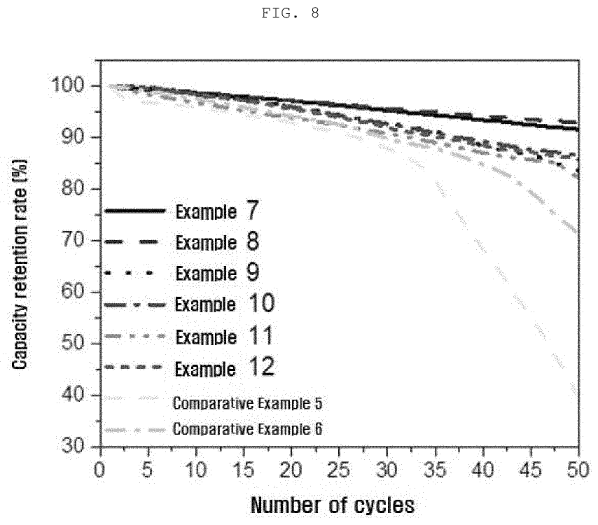

FIG. 8 and Table 3 show life characteristic evaluation data for the half-cells of Examples 7 to 12, and Comparative Examples 5 and 6.

TABLE 3

| | Capacity retention rate |
|---|---|
| Classification | after 50 cycles (%) |
| Example 7 | 91.5 |
| Example 8 | 92.2 |
| Example 9 | 83.6 |
| Example 10 | 86.7 |
| Example 11 | 82.3 |
| Example 12 | 85.8 |
| Comparative Example 5 | 71.2 |
| Comparative Example 6 | 39.2 |

It could be appreciated from these results that in Examples 7 to 12, even when the battery was repeatedly charged and discharged, reduction of the capacity was small and the life characteristics were improved.

Comparative Example 5 in which the composite layer and the carbon coating layer were not formed on the graphite particle and Comparative Example 6 in which the carbon coating layer was not formed on the composite layer could be confirmed to have very poor life characteristics.

Meanwhile, Examples 10 and 12 manufactured by employing the anode active material in which the crystalline silicon was used as a raw material or the firing temperature for the second composite precursor was more than 700° C., and thus the composite layer has a high degree of crystallinity, showed life characteristics relatively poorer than those of Examples 7 and 8.

In addition, Examples 9 and 11 manufactured by employing the anode active material in which the firing temperature with respect to the second composite precursor was lower than 600° C., the initial efficiency and life characteristics were relatively poorer than those of Examples 7 and 8. This is considered to be the result that the carbonization of the pitch was not sufficiently performed as compared with Examples 7 and 8.

It was confirmed from the above-described Examples that the anode active material of the present invention included the carbon-based particle, the composite layer positioned on the carbon-based particle and including a silicon particle dispersed in the carbon matrix, and the carbon coating layer positioned on the composite layer, and thus the discharge capacity was very good and the life characteristics were also excellent as compared to those of the known anode active materials.

Further, it was confirmed that when the amorphous silicon particle was used as the raw material of the silicon particle of the composite layer, the life characteristics were excellent.

In addition, it could be appreciated that when the second composite precursor was fired at a temperature of 600 to 700° C., the life characteristics were excellent as compared to cases where the firing temperature was higher or lower than that.

The anode active material for a lithium secondary battery according to an embodiment of the present invention may have a high content of silicon to have high capacity characteristics and may effectively prevent electrical isolation and peeling, etc., that are caused by volume expansion of silicon. In addition, the silicon interface may be prevented from being directly exposed to the electrolyte, such that generation of side reactions with the electrolyte and depletion of the electrolyte may be suppressed. Thus, excellent life characteristics of the secondary battery may be realized.

In addition, the present invention also provides a manufacturing method capable of economically mass-producing the anode active material having the above-described advantages through a simple process.

Further, the present invention provides a secondary battery including the anode active material having the above-described advantages.

What is claimed is:

1. A manufacturing method of an anode active material for a lithium secondary battery comprising:
stirring a mixture of a carbon-based particle, a silicon particle, and a first carbon precursor, thereby obtaining a first composite precursor in which the silicon particle dispersed in the first carbon precursor is positioned on the carbon-based particle,
stirring a mixture of the first composite precursor and a second carbon precursor, thereby obtaining a second composite precursor in which the second carbon precursor is positioned on the first composite precursor, and
firing.

2. The manufacturing method of claim 1, wherein the silicon particle is an amorphous silicon particle.

3. The manufacturing method of claim 1, wherein the stirring in the obtaining of the first composite precursor and/or the second composite precursor is performed by spraying a solvent.

4. The manufacturing method of claim 1, wherein 10 wt % or more to 90 wt % or less of the carbon-based particle, 5 wt % or more to 50 wt % or less of the sum of the silicon particle and the first carbon precursor, and 5 wt % or more to 40 wt % or less of the second carbon precursor are mixed with respect to a total mixed amount of the carbon-based particle, the silicon particle, the first carbon precursor, and the second carbon precursor.

5. The manufacturing method of claim 1, wherein 0.5 wt % or more to 30 wt % or less of the silicon particle is mixed with respect to a total mixed amount of the carbon-based particle, the silicon particle, the first carbon precursor, and the second carbon precursor.

6. The manufacturing method of claim 1, wherein a firing temperature in the firing is 600° C. or more to 700° C. or less.
